(19) United States
(12) Patent Application Publication
(10) Pub. No.: US 2024/0017166 A1
(43) Pub. Date: Jan. 18, 2024

(54) SYSTEMS AND METHODS FOR GENERATING REAL-TIME DIRECTIONAL HAPTIC OUTPUT

(71) Applicant: Tim Hoar, Redmond, WA (US)

(72) Inventor: Tim Hoar, Redmond, WA (US)

(21) Appl. No.: 18/350,462

(22) Filed: Jul. 11, 2023

Related U.S. Application Data
(60) Provisional application No. 63/388,378, filed on Jul. 12, 2022.

(51) Int. Cl. A63F 13/28; H04S 3/00

(52) U.S. Cl. CPC A63F 13/28; H04S 3/008; H04S 2400/01; H04S 2400/15

(57) ABSTRACT

Systems and methods for generating real-time directional haptic output that is capable of being perceived by a user. A system is described that includes a haptic computing device configured to receive an audio input and provide real-time directional haptic output capable of being perceived by a user. The haptic computing device is to receive an audio input. A haptic output device is coupled to the haptic computing device and provides real-time directional haptic output. A computer-implemented method for generating real-time directional haptic output is also described.

### CROSS-REFERENCE TO RELATED APPLICATIONS

This application claims the benefit of provisional U.S. Patent Application No. 63/388,378, titled “SYSTEMS AND METHODS FOR GENERATING REAL-TIME DIRECTIONAL HAPTIC OUTPUT” and listing Tim Hoar as inventor, filed Jul. 12, 2022. The entire contents of the above-referenced application and of all priority documents referenced in the Application Data Sheet filed herewith are incorporated by reference herein, in their entireties, for all purposes.

### FIELD

The present application relates to audio processing and more specifically, to systems and methods for generating real-time directional haptic output.

### BACKGROUND

Recent advancements in spatial audio technology have further transformed game audio, resulting in a more immersive and realistic sound environment in which players experience sounds rather than simply hearing them. It is possible to employ sound effects as cues to improve spatial awareness and make games more dynamic. Some of these sounds enhance the atmosphere or provide a sense of scale.

In games that largely rely on spatial audio, hearing-impaired players might experience difficulty hearing or understanding some of the audio signals. As more people become aware of these accessibility issues, game designers are attempting to create more inclusive and accessible game designs. To improve their gaming experience, hearing-impaired players can use haptic output in addition to the game's audio. Games with haptic feedback for spatial audio cues can give players tactile feedback to make up for the absence of directional audio cues.

There are existing integrations of haptic feedback to create more immersive gaming experiences. These haptic integrations must be implemented in each game, which is not well-suited to provide a consistent and immersive experience.

There is a need for a solution that provides directional feedback in order to create a game-agnostic experience that can be used in any game that uses spatial audio.

### SUMMARY OF THE INVENTION

The systems and methods of the present application have been developed in response to the present state of the art, and in particular, in response to the problems and needs in the art that have not yet been fully solved by currently available haptic integrations. Thus, it is an overall objective of the present application to provide real-time directional haptic cues.

To achieve the foregoing object, and in accordance with the invention as embodied and broadly described herein in the preferred embodiments, a system and method for generating real-time direction haptic output is provided.

According to some embodiments, a system for generating real-time directional haptic output is described. The system includes a haptic computing device. The haptic computing device is to receive an audio input, process audio input into a plurality of channels, identify a plurality of audio events within the audio input, determine weights for each of the plurality of audio events, determine a dominant channel for each of the plurality of audio events, and generate a real-time directional haptic output associated with a determined dominant channel and time information. The haptic computing device is coupled to a haptic output device. The haptic output device receives the real-time directional haptic output from the haptic computing device.

According to some embodiments, a computer-implemented method for generating real-time directional haptic output is described. A haptic computing device is to receive an audio input, process audio input into a plurality of channels, identify a plurality of audio events within the audio input, determine weights for each of the plurality of audio events, determine a dominant channel for each of the plurality of audio events, and generate a real-time directional haptic output associated with a determined dominant channel and time information. The haptic computing device is coupled to a haptic output device. The haptic output device receives the real-time directional haptic output from the haptic computing device.

According to some embodiments, the weights for each of the plurality of audio events are determined using absolute values and a rate of change within each of the plurality of audio events.

According to some embodiments, the dominant channel for each of the plurality of audio events is determined by comparing the weights, a ratio of the weights, or a time-weighted difference between the weights.

According to some embodiments, the dominant channel for each of the plurality of audio events is determined by determining a time-weighted rate of change of the weights for each of the plurality of audio events across the plurality of channels.

According to some embodiments, the haptic computing device is to filter the plurality of audio events to a determined frequency range.

According to some embodiments, identifying the plurality of audio events within the audio input includes processing the audio input into frequency spectrum.

According to some embodiments, the haptic computing device further generates a frequency compressed output associated with the determined dominant channel.

The foregoing summary is illustrative only and is not intended to be in any way limiting. Features from any of the disclosed embodiments can be used in combination with one another, without limitation. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a functional block diagram illustrating an example system configured to generate real-time directional and haptic output, according to some embodiments.

FIG. 2 is a functional block diagram illustrating another example system configured to generate directional audio cues and real-time directional haptic output, according to some embodiments.

FIG. 3 is a flowchart illustrating an example method for generating real-time directional haptic output, according to some embodiments.

### DETAILED DESCRIPTION

This application discloses improved systems and methods for generating real-time directional haptic output.

Real-time directional haptic output can enhance a user's perception of sound. Haptic directional cues are especially helpful for hearing-impaired people to get directional information from the sounds around them. Video game players can also use the haptic output supplemental to the game audio.

Vibration, texture, or massage are examples of haptic or tactile feedback. Instead of hearing the audio content, the user can experience it through vibrations. Human body parts can experience haptic sensations by coming into contact with haptic output devices, such as the finger, palm, wrist, arm, leg, top of the head, and jawbone. One of the best ways to experience haptic feedback is by vibration on the user's fingertips. Users can feel small changes in pressure, texture, and temperature due to the extremely high density of nerve fibers in the fingertips. Additionally, users can experience haptic feedback from devices like bone conduction transducers.

The current disclosure has several advantages. It eliminates the need for developer-specific support and makes use of the stereo audio that already exists to provide directional feedback. It also removes background noise from consideration by allowing video game players to adjust the sensitivity of the input and intensity of the output for each game, as well as the amount of feedback desired.

In the following detailed description, reference is made to the accompanying drawings, which form a part hereof. In the drawings, similar symbols typically identify similar components unless context dictates otherwise. The illustrative embodiments described in the detailed description, drawings, and claims are not meant to be limiting. Other embodiments may be utilized, and other changes may be made, without departing from the spirit or scope of the subject matter presented here.

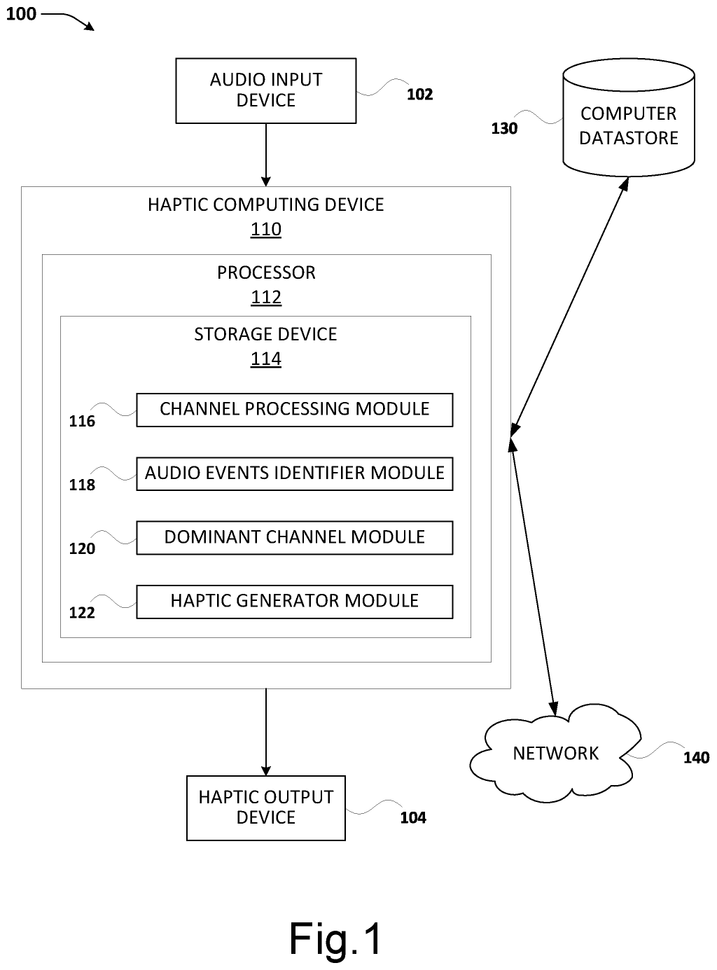

FIG. 1 is a functional block diagram illustrating a system 100 configured to generate real-time directional and haptic output, according to some embodiments. System 100 includes an audio input device 102, a haptic computing device 110, a processor 112, a storage device 114, and a haptic output device 104. The haptic computing device may be connected to computer datastore 130 and network 140. Haptic output device 104 may communicate with one or more other computing devices via network 140. FIG. 1 illustrates only one particular example of system 100, and many other examples of system 100 may be used in other instances and may include a subset of the components included in the system 100. System 100 may include additional components not shown in FIG. 1.

Processor 112 may include one or more execution cores (CPUs). For example, haptic computing device 110 may also include a peripheral controller hub (PCH) (not shown). Processors 112 may implement functionality and/or execute instructions within haptic computing device 110. For example, processor 112 may receive and execute instructions stored by storage device 114 that provides the functionality of haptic computing device 110. These instructions executed by processor 112 may cause haptic computing device 110 to store and/or modify information within storage device 114 during program execution.

Storage device 114 may generally comprise a random access memory (“RAM”), a read-only memory (“ROM”), and a permanent mass storage device, such as a disk drive or SDRAM (synchronous dynamic random-access memory). Haptic computing device 110 may store program code for modules and/or software routines. Storage device 114 may store one or more processes (i.e., executing software application(s)). These software components may be loaded from a non-transient computer-readable storage medium into the storage device 114 using a drive mechanism associated with a non-transient computer-readable storage medium, such as a floppy disc, tape, DVD/CD-ROM drive, memory card, or other like a storage medium. In some embodiments, software components may also or instead be loaded via a mechanism other than a drive mechanism and computer-readable storage medium.

Audio input 102 may be a microphone, instrument, synthesizer, or other devices that provide an audio input signal to haptic computing device 110 for processing. The audio input contains more than one channel.

Haptic output device 104 may be any suitable device for providing haptic feedback, such as motors (e.g., spinning motor, servo motor, or piezoelectric motor) and sensors that generate vibration, force and/or motions. The haptic output device may be a wearable device. Human body parts (e.g., finger, palm, wrist, arm, leg, top of head, jawbone) can perceive haptic sensation through the contact between the skin and a haptic output device. Being felt on a user's fingertips through vibration is the ideal way to perceive haptic feedback. The density of nerve fibers in the fingertips is incredibly high, which means users can detect even the slightest changes in pressure, texture, and temperature. Haptic output device 104 may operate in conjunction with one or more devices to transmit the haptic output for the user's perception. For example, a fastener or a strap may be useful to affix the haptic output device 104 so that the user can place his or her fingers in touch with the motor or sensor to sense the haptic feedback.

System 100 may include other input and output devices, for example, user interface device(s) including a display, a touch-screen display, printer, keypad, keyboard, etc., sensor(s) including accelerometer, global positioning system (GPS), gyroscope, etc., communication logic, wired and/or wireless, storage device(s) including hard disk drives, solid-state drives, removable storage media, etc. I/O ports for input devices and output devices may be configured to transmit and/or receive commands and/or data according to one or more communications protocols. For example, one or more of the I/O ports may comply and/or be compatible with a universal serial bus (USB) protocol, peripheral component interconnect (PCI) protocol (e.g., PCI express (PCIe)), or the like.

The haptic computing device 110 may include channel processing module 116, audio events identifier module 118, dominant channel module 120, and haptic generator module 122. In an embodiment, the haptic computing device 110 receives audio streams from audio input device 102 or audio files stored in computer datastore 130. The audio streams are split into a plurality of channels. The channels include at least a left and right channel.

System 100 may work in conjunction with other devices, such as an amplifier, to enhance the power of output. System 100 may include additional external controllers to receive user input or parameters, e.g., a volume controller or a sensitivity controller.

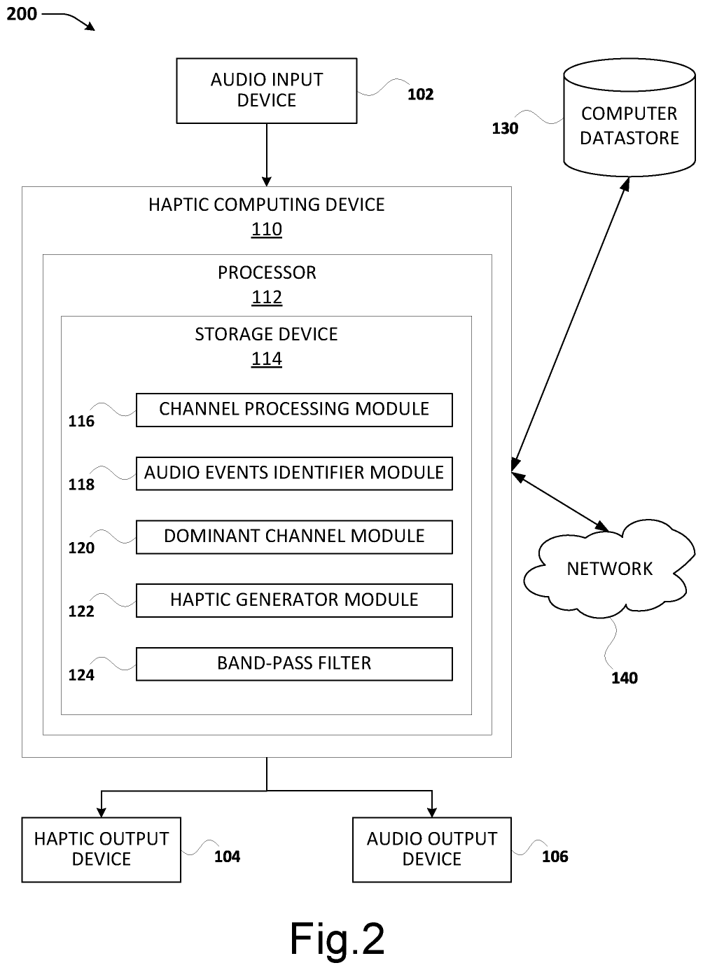

FIG. 2 is a block diagram of an example system 200 configured to generate directional audio cues and real-time directional haptic output, according to some embodiments. Compared to system 100 as shown in FIG. 1, system 200 includes an audio output device coupled to the haptic computing device 110. Audio output device 106 may be a speaker, headphones, bone conductor transducer, bone conduction headphone, or other hearing devices. In some embodiments, audio output device 106 and haptic output device 104 may be integrated into one device. For example, bone conduction headphones can produce both auditory output capable of being heard by a user and haptic output capable of being perceived by the user.

Haptic computing device 110 may include a band-pass filter 124. The band-pass filter 124 is to process the audio data and feeds the audio data to audio output device 106. The band-pass filter 124 may operate in sequence or parallel to other modules of the haptic computing device 110 to convey information associated with the audio data.

System 200 may include a mixer (not shown) to combine audio and haptic output. Mixer 206 may be suitable when the haptic output device 104 and the audio output device 106 are integrated and receive one combined signal from haptic computing device 200. In some example embodiments, the mixer may combine audio output and haptic output into combined audio and haptic data.

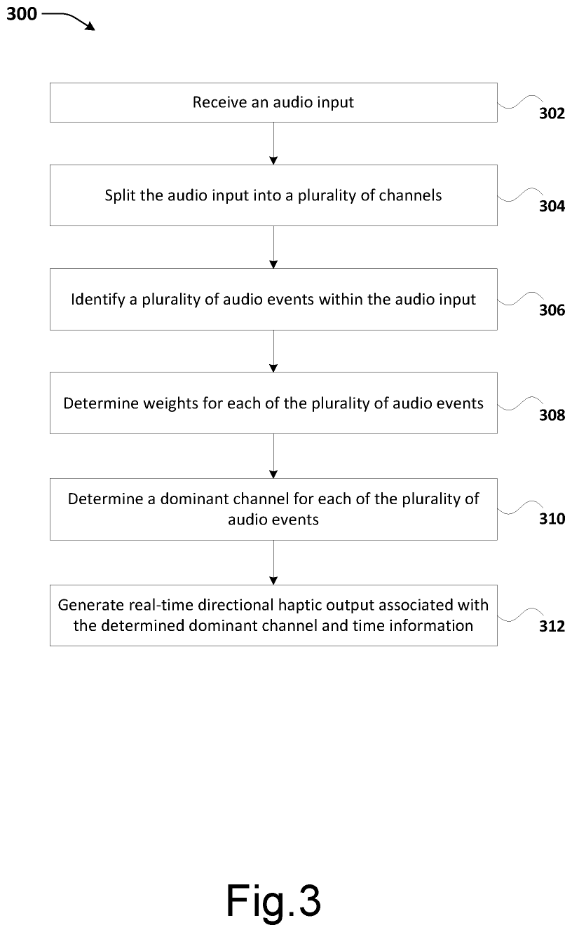

FIG. 3 is a flowchart illustrating an example method 300 for generating real-time directional haptic output, according to some embodiments. Method 300 can be carried out, in part, by processor 112 of the haptic computing device 110.

At block 302, the haptic computing device 110 receives audio input. The audio input can be from any stereo, or multi-channel audio source. The haptic computing device 110 may receive the audio input from audio input device 102. In an example embodiment, the haptic computing device 110 receives a stereo audio stream having two channels. The audio stream may be a fixed size based on the sample rate of the audio and the number of samples being used. In an example embodiment, the sample rate is 44.1 kHz, and the buffer size is 2048 for each channel.

At block 304, channel processing module 116 splits the audio input into at least two channels, e.g., at least a left and a right channel. Five or seven channels may be provided to have more positional data. After being split, the channels may be further processed to remove background noise.

At block 306, audio events are identified. Audio events identifier module 118 identifies audio events that contain significant information about the audio stream. For instance, an audio event may be significant changes with the frequency domain of a single channel. The audio events may be roughly grouped to match definitions of the audio spectrum, such as 20 Hz-60 Hz for sub-bass and 60 Hz-250 Hz for bass.

There are various ways to identify the audio events. The audio stream is converted into frequency domain for each channel. The audio events may be identified by looking for historical changes in the frequency spectrum. A baseline and subsequent changes are recorded and tracked. The audio events may also be identified by significant differences within the frequency domain of a single channel. The audio events may also be identified by significant changes in the absolute value of the difference between the channels, either against historical data or adjacent frequencies.

At block 308, dominant channel module 120 identifies weights for each of the audio events. One or more weights may be generated for each of the audio events. In an example embodiment, the weights may be generated by either extracting the maximum amplitude or averaging the amplitude within that range. For example, in the lower frequencies, there is little difference between the two, while in the higher frequency bands, the maximum amplitude catches more subtle details but also generates extra noise.

At block 310, the dominant channel module 120 determines a dominant channel for each of the audio events. Audio events may occur across channels. The frequency range of each audio event is dynamically compared across channels. Audio events may also occur across bands. The frequency spectrum may further split into frequency bands and be compared after the audio events have been identified.

The weights can be used to determine whether there is a dominant channel for each audio event. In an example embodiment, within each audio event, the channels are compared using the differences between weights, a ratio of the weights, or a time-weighted difference between the weights. In another embodiment, the channels are compared using a time-weighted rate of change of weights. Based on these comparisons, if there is a significant difference between the weights for each audio event, the channels will be classified as dominant. If there is no significant difference, the channels will be labeled neutral. In an example embodiment, the first and second comparisons are being used, but there is no historical tracking.

At block 312, a haptic output associated with the determined dominant channel and time information is generated by the haptic generator module 122. In an embodiment, a brief history of the audio channel may be used to determine the rate of change of the channel, with rapid changes being given more weight than constant sounds. In yet another example embodiment, the prioritized weights determined for each audio event can be used to set a value at a single frequency in the output channel. These values may also be modulated so the output happens at fixed intervals rather than continuously. If modulated, the intervals vary by frequency, so the lower frequencies generate larger feedback less often. As an example, the lowest frequency causes a pulse in the output four times per second. Every 250 ms, the prioritized weight is used to generate a single pulse at the index value corresponding to 50 Hz. Between output pulses, the weighted priority value is tracked to re-determine the dominant channel(s). There is no historical tracking in this example.

In an example embodiment, the described method generates five output signals that can be easily converted to more discrete output. This output may include a single vibrating motor for each signal frequency band, or it may be simplified further to use fewer outputs. The frequency-domain signals are converted back to time-domain audio and haptic output. In an example embodiment, the incoming audio and haptic output may be merged into a single stereo audio signal. The merged stream may be fed to a haptic output device, e.g., haptic transducers, as an audio signal.

Classifications may be used to generate and tune the output weight. The output weight varies by frequency range associated with the audio events. The haptic computing device 110 may optionally output audio stream to audio output device 106, or work with other computing devices to output audio stream. For example, in lower frequencies, a primary multiplier is 2, so any output from the primary side will be doubled. A secondary modifier is 0, removing all output for that frequency range from that channel. In the case of no audio event being identified, a small modifier can be applied to each channel to provide some feedback rather than going completely silent.

The haptic computing device 110 may be connected to a band-pass filter 124. The identified audio events may be grouped or filtered to a determined frequency range. Each audio event in each channel may be multiplied by the prioritized weight to emphasize the differences. Frequencies above the considered range, e.g., above 6 kHz, may be removed. Each frequency range is then compressed to shift the entire output into a range that can provide usable haptic feedback. The compression factor is dependent on the frequency range, with higher frequencies being more compressed. This step is only usable when the output device can play audio steam or other high-frequency output.

The present disclosure has been described with reference to specific embodiments. The invention is not intended to be limited to any such particulars or embodiments or any particular embodiment, but it is to be construed with references to the appended claims so as to provide the broadest possible interpretation of such claims in view of the prior art and effectively encompass the intended scope of the invention.

Aspects of the present embodiments may be embodied as a system, method or computer program product. Accordingly, aspects of the present disclosure may take the form of an entire hardware embodiment, an entire software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

The use of “including,” “comprising,” or “having” and variations thereof herein is meant to encompass the items listed thereafter and equivalents thereof as well as additional items. Unless specified or limited otherwise, the terms “affixed,” “associated,” “attached,” “connected,” “coupled” and “supported,” and variations thereof are used broadly and encompass both direct and indirect connections, supports, and couplings. It is to be understood that other embodiments may be utilized, and structural or logical changes may be made without departing from the scope of the present disclosure.

What is claimed is:

1. A system for generating real-time directional haptic output, comprising:
a haptic computing device, the haptic computing device configured to:
receive an audio input;
process audio input into a plurality of channels;
identify a plurality of audio events within the audio input;
determine weights for each of the plurality of audio events;
determine a dominant channel for each of the plurality of audio events;
generate a real-time directional haptic output associated with a determined dominant channel and time information; and
a haptic output device coupled to the haptic computing device, the haptic output device to receive the real-time directional haptic output from the haptic computing device.

2. The system of claim 1, wherein determining the weights for each of the plurality of audio events comprises using absolute values and a rate of change within each of the plurality of audio events.

3. The system of claim 1, wherein determining the dominant channel for each of the plurality of audio events comprises comparing the weights, a ratio of the weights, or a time-weighted difference between the weights.

4. The system of claim 1, wherein determining the dominant channel for each of the plurality of audio events comprises determining a time-weighted rate of change of the weights for each of the plurality of audio events across the plurality of channels.

5. The system of claim 1, wherein the haptic computing device is further configured to filter the plurality of audio events to a determined frequency range.

6. The system of claim 1, wherein identifying the plurality of audio events within the audio input comprises processing the audio input into frequency spectrum.

7. The system of claim 1, wherein the haptic computing device further generates a frequency compressed output associated with the determined dominant channel.

8. A computer-implemented method for generating real-time directional haptic output, comprising:
receiving an audio input, by a haptic computing device, the haptic computing device configured to:
process the audio input to a plurality of channels;
identify a plurality of audio events within the audio input;
determine weights for each of the plurality of audio events;
determine a dominant channel for each of the plurality of audio events;
generate a real-time directional haptic output associated with a determined dominant channel and time information; and
provide the real-time directional haptic output to a haptic output device, the haptic output device coupled to the haptic computing device.

9. The method of claim 8, wherein determining the weights for each of the plurality of audio events comprises using absolute values and a rate of change within each of the plurality of audio events.

10. The method of claim 8, wherein determining a dominant channel for each of the plurality of audio events comprises comparing the weights, a ratio of the weights, or a time-weighted difference between the weights.

11. The method of claim 8, wherein determining a dominant channel for each of the plurality of audio events comprises determining a time-weighted rate of change of the weights within each of the plurality of audio events across the plurality of channels.

12. The method of claim 8, wherein identifying the plurality of audio events within the audio input comprises processing the audio input into frequency spectrum.

13. The method of claim 8, further comprises generating a frequency compressed output associated with the determined dominant channel.

14. The method of claim 8, further comprises filtering the plurality of audio events to a determined frequency range.
